(19) United States
(12) Patent Application Publication
(10) Pub. No.: US 2013/0297653 A1
(43) Pub. Date: Nov. 7, 2013

(54) METADATA STORAGE MANAGEMENT OFFLOADING FOR ENTERPRISE APPLICATIONS

(71) Applicants: Naresh K. Chainani, Portland, OR (US); Punit B. Shah, Portland, OR (US)

(72) Inventors: Naresh K. Chainani, Portland, OR (US); Punit B. Shah, Portland, OR (US)

(73) Assignee: International Business Machines Corporation, Armonk, NY (US)

(21) Appl. No.: 13/462,792

(22) Filed: May 2, 2012

(51) Int. Cl. G06F 17/30

(52) U.S. Cl. 707/783; 707/E17.005; 707/E17.01

(57) ABSTRACT

A method for offloaded handling of metadata storage management in a utility file system includes trapping a request for a file operation from an application process directed to a specified file of metadata stored in a utility file system of a host data processing system. The method further includes determining whether the application process is part of a privileged application or an unprivileged application and restricting access to the specified file if it is determined that the application process is part of an unprivileged application, but otherwise transforming the specified request into at least one predetermined operation if it is determined that the application process is part of a privileged application and directing the performance of the predetermined operation in the utility file system.

### BACKGROUND OF THE INVENTION

1. Field of the Invention

The present invention relates to metadata management and more particularly to metadata storage management for an enterprise application in a utility file system.

2. Description of the Related Art

Many enterprise applications produce and use persistent state information also referred to as meta-data in order to maintain by the enterprise application. In this regard, the state information is not to be confused with end user data. Rather, the state information is information required by the application itself to function correctly and to support application semantics. For a database system—the most common element of an enterprise application, meta-data includes transaction log files, log control files, directory caches and the like.

In the context of a DBMS, database metadata can be viewed in two ways. First, metadata can be stored within a database and referred to as the “catalog”. Database metadata also can be stored externally to the database in a utility file system. Generally, the catalog includes table space information including tables of all tables in database including names, sizes and number or rows in each table. The catalog also can include tables of columns in each database including the type of data in each column and what tables they are used in. Database metadata also can include storage path information, buffer pool information, database configuration information, historical changes to the table space information and a log control data. Of note, with respect to the table space information, in a typical DBMS, the table space information can be stored in mirrored fashion in duplicated files to account for a backup file when the primary file becomes corrupted. Of further note, generally log files are not stored as metadata within the database, but as metadata within the utility file system.

More specifically, a DBMS uses the regular file system provided by an underlying operating system of a host server to store some database metadata. However, unlike data written through the DBMS, in the regular “utility” file system, end user actions outside of the control of the DBMS are permitted including removal (deletion), modification and movement from one location in the file system to another. In a utility file system, the actions of the end user in respect to any metadata file is limited not by the DBMS, but merely by the appropriate level of access granted by the file system to the end user to perform the operation. Thus, even prudent use of utility file system permissions allow only limited protection against such inadvertent destructive actions.

In anticipation of an end user inadvertently compromising the operation of the DBMS through utility file system manipulation of a metadata file, DBMS can be designed to repair and/or recover from lost or corrupted meta-data in a meta data file. Specifically, a typical DBMS incorporates a significant quantity of defensive code designed to mitigate inadvertent end user actions performed upon meta data files through the utility file system. This defensive code, however, adds to code complexity, maintainability, testing, and lower performance of the DBMS. Worse yet, in spite of the defensive code, on most occasions it is not possible to recover from the corruption or loss of the meta data files requiring the restoration of the entire database in the DBMS.

### BRIEF SUMMARY OF THE INVENTION

Embodiments of the present invention address deficiencies of the art in respect to metadata storage management for enterprise applications and provide a novel and non-obvious method, system and computer program product for offloaded\handling of metadata storage management in a utility file system. In an embodiment of the invention, a method for offloaded handling of metadata storage management in a utility file system is provided. The method includes trapping a request for a file operation from an application process directed to a specified file of metadata stored in a utility file system of a host data processing system, determining whether the application process is part of a privileged application or whether the application process is part of an unprivileged application and restricting access to the specified file if it is determined that the application process is part of an unprivileged application, but otherwise transforming the specified request into at least one predetermined operation if it is determined that the application process is part of a privileged application and directing the performance of the predetermined operation in the utility file system.

In another embodiment of the invention, a host data processing system is provided. The system includes fixed storage and at least one host computer with memory and at least one processor and coupled to the fixed storage. The system also includes an operating system hosting execution of a enterprise application that may include a DBMS and providing a utility file system through which files are managed in the fixed storage. Finally, the system includes a metadata management module executing in the memory of the host computer. The module includes program code enabled to trap a request for a file operation from an application process directed to a specified file of metadata stored by the utility file system in the fixed storage, to determine whether the application process is part of a privileged application or whether the application process is part of an unprivileged application, and to restrict access to the specified file if it is determined that the application process is part of an unprivileged application, but otherwise to transform the specified request into at least one predetermined operation if it is determined that the application process is part of a privileged application and directing the performance of the predetermined operation in the utility file system.

In one aspect of the embodiment, the metadata can include tablespace information for a database in the DBMS. In another aspect of the embodiment, an application process is determined to be part of a privileged application if the application process is part of an application associated with an open session established for a privileged application with a logic layer disposed between the utility file system and the requesting application process. Alternatively, an application process is determined to be part of a privileged application if the application process submits along with the request a token associated with a privileged application. In yet another aspect of the embodiment, the restricted access is a rejection of the request. Finally, in even yet another aspect of the embodiment, the predetermined operation is the performance of the file operation on different mirrored images of the specified file, or the performance of the file operation using either a buffered or non-buffered option.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for offloaded handling of metadata storage management in a utility file system;

FIG. 2 is a schematic illustration of a host data processing system configured for offloaded handling of metadata storage management in a utility file system; and,

FIG. 3 is a flow chart illustrating a process for offloaded handling of metadata storage management in a utility file system.

### DETAILED DESCRIPTION OF THE INVENTION

Embodiments of the invention provide for offloaded handling of metadata storage management in a utility file system. In accordance with an embodiment of the invention, a request to access a specified file in a utility file system of a host data processing system can be trapped and processed to identify a source process issuing the request. If the source process is determined to be of an unprivileged class, the request can be rejected as unauthorized or permitted only where the request is of a particular type. However, if the source process is determined to be of a privileged class, the request can be transformed into one or more series of predetermined operations. Those operations can include the creation of one or more additional files in relationship to the specified file, the removal of the specified file, the movement of the specified file from one location in the utility file system to another, the opening of the specified file and possibly a mirrored form of the specified file, the writing to the file and possibly a mirrored form of the specified file, and the reading from the specified file and possibly from a mirrored form of the specified file should the specified file be determined corrupt. Thereafter, the operations can be directed upon the utility file system. In this way, the necessity of defensive code to manage the opportunity for an end user to tamper with a database metadata file can become obviated.

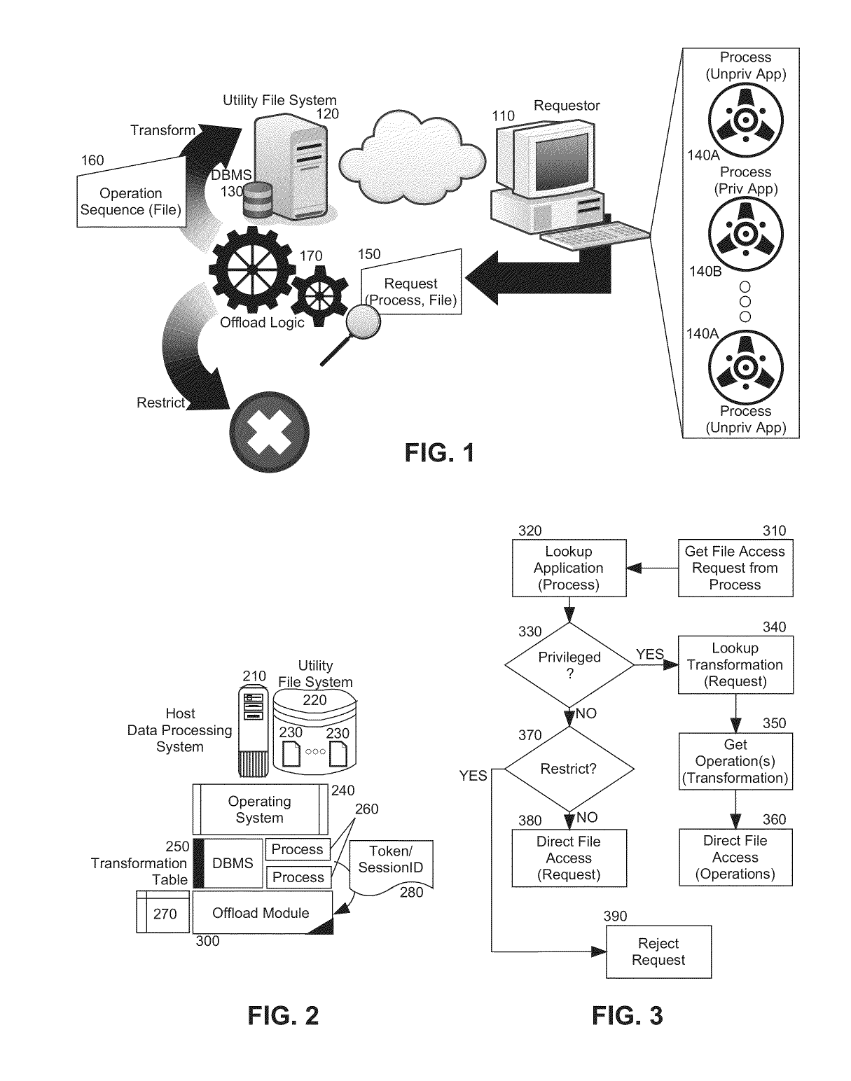

In further illustration, FIG. 1 is a pictorial illustration of a process for offloaded handling of metadata storage management in a utility file system. As shown in FIG. 1, a utility file system 120 of a host data processing system supporting the operation of an enterprise application that may include, for instance, a DBMS 130, can receive file access requests 150 such as create, open, close, write and read operations. Off load logic 170 associated with the utility file system 120 can trap the file access requests 150 before the file access requests 150 can be handled by the utility file system 120. Once a file access request 150 for a specified file containing metadata for the DBMS 130 in the utility file system 120 has been trapped, the process 140A, 140B of the requestor 110 can be inspected to determine whether or the process 140A is that of an unprivileged application, or whether the process 140B is that of a privileged application.

For file access requests 150 from a process 140A of an unprivileged application, the offload logic 170 can restrict the execution of file access requests 150—for example by rejecting the file access request 150. In contrast, for file access requests 150 from a process 140B of a privileged application, the offload logic 170 can transform the file access request 150 into one or more operations 160 such as performing the desired operation for mirrored images of the specified file. In this way, access to the specified file containing the metadata for the DBMS 130 can be managed in a way so as to obviate the need for defensive code while eliminating the threat of end user induced file corruption, deletion or relocation.

The process described in connection with FIG. 1 can be implemented in a host data processing system. In yet further illustration, FIG. 2 schematically shows a host data processing system configured for offloaded handling of metadata storage management in a utility file system. The system can include a host data processing system 210 that includes one or more host computers each with at least one processor and memory (only a single host computer shown for the purpose of illustrative simplicity). The host data processing system 210 can include an operating system 240 supporting a utility file system 220, as well as a DBMS 250 for an enterprise application and multiple different processes 260 for multiple different corresponding applications (not shown).

Of note, the operating system 240 additionally can support the operation of an offload module 300 in the memory of the host data processing system 210. The offload module 300 can be a layer disposed between the utility file system 210 and an application issuing file requests to the utility file system 210 and can include program code that when executed in the memory of the host data processing system 210 can trap a file request from a process 260 to access a database metadata file 230 in the utility file system 220. The file request can include, for instance, a request to create the database metadata file 230, to remove the database metadata file 230, to move the database metadata file 230, to open the database metadata file 230, to write to the database metadata file 230, or to read from the database metadata file 230.

The program code then can determine whether or not the process 260 is associated with an application that is deemed privileged. In this regard, the process 260 can be considered associated with an application that is deemed privileged when the application enjoys an active session with the DBMS 250 according to an active session identifier 280 provided with the file request. Alternatively, the process 260 can be considered associated with an application that is deemed privileged when the application submits with the file request a token or key 280 known to the offload module 300 to be associated with a privileged application.

To the extent the process 260 is determined to be associated with an unprivileged application, the file request can be rejected where the file request is one of a remove, open or read operation. Optionally, in the instance of a create operation, the file operation can be permitted. Further, to the extent the file request is one of a move operation, the operation can be permitted where the database metadata file 230 is a log file and the destination for the move operation is an archive location. In any event, to the extent the process 260 is determined to be associated with a privileged application, the file request can be transformed into one or more operations in support of the DBMS 250.

In this regard, a transformation table 270 can be consulted in which different file access requests correspond to a different operation or sequence of operations. For example, in the event of a create operation, the specified database metadata file 230 can be created in two mirrored files and, optionally, a buffered or non-buffered option can be set for the database metadata file 230 where appropriate. Similarly, for an open operation, corresponding mirrored files can be opened, for a write operation, both mirrored files can be written to with the same data, and for a read operation, a mirrored file can be accessed in lieu of a primary file where the primary file is determined to be corrupt or outdated.

In even yet further illustration of the operation of the offload module 300, FIG. 3 is a flow chart illustrating a process for offloaded handling of metadata storage management in a utility file system. Beginning in block 310, a file access request can be received from a process and in block 320, an application corresponding to the process can be determined. In decision block 330, it can be determined whether or not the application is deemed privileged. If so, in block 340 a transformation for the file request can be identified and in block 350 one or more operations of the transformation can be retrieved. Finally, in block 360 the retrieved operations can be applied to the utility file system.

In decision block 330, if it is determined that the application is deemed unprivileged, in decision block 370 it further can be determined whether or not the file access request is to be restricted or permitted. If permitted, in block 380 the file access request can be passed through to the utility file system. Otherwise, in block 390 the file access request can be rejected.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for offloaded handling of metadata storage management in a utility file system, the method comprising:
trapping a request for a file operation from an application process directed to a specified file of metadata stored in a utility file system of a host data processing system comprising one or more host computers each with memory and at least one processor;
determining whether the application process is part of a privileged application or whether the application process is part of an unprivileged application; and
restricting access to the specified file if it is determined that the application process is part of the unprivileged application, but otherwise transforming the specified request into at least one predetermined operation if it is determined that the application process is part of the privileged application and directing the performance of the at least one predetermined operation in the utility file system.

2. The method of claim 1, wherein the metadata comprises tablespace information for a database in a database management system (DBMS).

3. The method of claim 1, wherein an application process is determined to be part of a privileged application when it is determined that the application process is part of an application associated with an open session established for the privileged application with a logic layer disposed between the utility file system and the requesting application process.

4. The method of claim 1, wherein an application process is determined to be part of a privileged application when it is determined that the application process submits along with the request a token associated with the privileged application.

5. The method of claim 1, wherein the restricted access is a rejection of the request.

6. The method of claim 1, wherein the at least one predetermined operation is the performance of the file operation on different mirrored images of the specified file.

7. The method of claim 1, wherein the at least one predetermined operation is the performance of the file operation using either a buffered or non-buffered option.

8. A host data processing system comprising:
fixed storage;
at least one host computer with memory and at least one processor and coupled to the fixed storage;
an operating system hosting execution of an enterprise application and providing a utility file system through which files are managed in the fixed storage; and
a metadata management module executing in the memory of the at least one host computer, the module comprising program code enabled to trap a request for a file operation from an application process directed to a specified file of metadata stored by the utility file system in the fixed storage, to determine whether the application process is part of a privileged application or whether the application process is part of an unprivileged application, and to restrict access to the specified file if it is determined that the application process is part of the unprivileged application, but otherwise to transform the specified request into at least one predetermined operation if it is determined that the application process is part of the privileged application and directing the performance of the at least one predetermined operation in the utility file system.

9. The system of claim 9, wherein the metadata comprises tablespace information for a database in a database management system (DBMS) included as part of the enterprise application.

10. The system of claim 9, wherein an application process is determined to be part of a privileged application when it is determined that the application process is part of an application associated with an open session with established for the privileged application with a logic layer disposed between the utility file system and the requesting application process.

11. The system of claim 9, wherein an application process is determined to be part of a privileged application when it is determined that the application process submits along with the request a token associated with the privileged application.

12. The system of claim 9, wherein the restricted access is a rejection of the request.

13. The system of claim 9, wherein the at least one predetermined operation is the performance of the file operation on different mirrored images of the specified file.

14. The system of claim 9, wherein the at least one predetermined operation is the performance of the file operation using either a buffered or non-buffered option.

15. A computer program product for offloaded handling of metadata storage management in a utility file system, the computer program product comprising:
a computer readable storage medium having computer readable program code embodied therewith, the computer readable program code comprising:
computer readable program code for trapping a request for a file operation from an application process directed to a specified file of metadata stored in a utility file system of a host data processing system comprising one or more host computers each with memory and at least one processor;
computer readable program code for determining whether the application process is part of a privileged application or whether the application process is part of an unprivileged application; and
computer readable program code for restricting access to the specified file if it is determined that the application process is part of the unprivileged application, but otherwise transforming the specified request into at least one predetermined operation if it is determined that the application process is part of the privileged application and directing the performance of the at least one predetermined operation in the utility file system.

16. The computer program product of claim 15, wherein the metadata comprises tablespace information for a database in a database management system (DBMS).

17. The computer program product of claim 15, wherein an application process is determined to be part of a privileged application when it is determined that the application process is part of an application associated with an open session established for the privileged application with a logic layer disposed between the utility file system and the requesting application process.

18. The computer program product of claim 15, wherein an application process is determined to be part of a privileged application when it is determined that the application process submits along with the request a token associated with the privileged application.

19. The computer program product of claim 15, wherein the restricted access is a rejection of the request.

20. The computer program product of claim 15, wherein the at least one predetermined operation is the performance of the file operation on different mirrored images of the specified file.

21. The computer program product of claim 15, wherein the at least one predetermined operation is the performance of the file operation using either a buffered or non-buffered option.
